(19) United States
(12) Patent Application Publication
(10) Pub. No.: US 2026/0127018 A1
(43) Pub. Date: May 7, 2026

(54) SYSTEMS AND METHODS FOR TRACKING VIRTUAL MACHINE IMAGE VULNERABILITIES IN A DISTRIBUTED NETWORK

(71) Applicant: BANK OF AMERICA CORPORATION, CHARLOTTE, NC (US)

(72) Inventors: Brian Neal Jacobson, Granada Hills, CA (US); Pratap Dande, Saint Johns, FL (US); Dennis Vranjesevic, Kent Cliffs, NY (US); Tony Aidoo, Aubrey, TX (US); Noell York Eury, Stanfield, NC (US); Bojan Zdravkovic, Jersey City, NJ (US); Rahul Yaksh, Austin, TX (US)

(73) Assignee: BANK OF AMERICA CORPORATION, CHARLOTTE, NC (US)

(21) Appl. No.: 18/938,938

(22) Filed: Nov. 6, 2024

(51) Int. Cl. G06F 9/455; G06F 21/57

(52) U.S. Cl. CPC G06F 9/45558; G06F 21/577; G06F 2009/45562

(57) ABSTRACT

Systems, computer program products, and methods are described herein for tracking virtual machine image vulnerabilities in a distributed network. The present disclosure is configured to identify a virtual machine (VM) image; apply the identified VM image to a VM vulnerability scanner; determine, by the VM vulnerability scanner, the VM image is safe from a list of known vulnerabilities; update, based on the VM vulnerability scanner, an approved repository with the VM image that is determined as safe from known vulnerabilities; generate, by a VM provisioning engine, at least one VM from the approved repository; identify at least one address identifier associated with the generated VM; and update the approved repository with the identified at least one address identifier and link the at least one address identifier to the associated VM image the generated VM is based on.

### TECHNOLOGICAL FIELD

Example embodiments of the present disclosure relate to tracking virtual machine image vulnerabilities in a distributed network.

### BACKGROUND

In virtual machine environments, it has become increasingly difficult, time consuming, and computing resource intensive to accurately and in real time track vulnerabilities in newly generated virtual images and in real time track newly identified vulnerabilities in virtual machines that have already been deployed to various data centers, servers, devices, and/or the like in a distributed network. Further, these issues are exacerbated where virtual machines have already been deployed on different network devices (various data centers, servers, devices, and/or the like) and new vulnerabilities are identified and each of these virtual machines have to be tracked down and updated, recalled, deleted, and/or the like, before the vulnerabilities cause network security issues, data security issues, and processing issues within the virtual machines. Thus, there exists a need or a system, computer program product, and computer implemented method that can accurately, efficiently, and automatically track virtual machine vulnerabilities in these distributed network environment.

Applicant has identified a number of deficiencies and problems associated with tracking vulnerabilities in virtual machine images proactively and vulnerabilities in already deployed virtual machines after deployment. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for tracking virtual machine image vulnerabilities in a distributed network.

In one aspect, a system for tracking virtual machine image vulnerabilities in a distributed network is provided. In some embodiments, the system may comprise: a memory device with computer-readable program code stored thereon; at least one processing device operatively coupled to the at least one memory device and at least one communication device, wherein executing the computer-readable code is configured to cause the at least one processing device to: identify a virtual machine (VM) image; apply the identified VM image to a VM vulnerability scanner; determine, by the VM vulnerability scanner, the VM image is safe from a list of known vulnerabilities; update, based on the VM vulnerability scanner, an approved repository with the VM image that is determined as safe from known vulnerabilities; generate, by a VM provisioning engine, at least one VM from the approved repository; identify at least one address identifier associated with the generated VM; and update the approved repository with the identified at least one address identifier and link the at least one address identifier to the associated VM image the generated VM is based on.

In some embodiments, the VM image is generated by at least one of an external system, a platform, a cloud computing platform, or an image creator component.

In some embodiments, the vulnerability scanner is updated in real time at an instance where a new vulnerability is identified.

In some embodiments, the approved repository further comprises a plurality of VM components used in each VM image of the approved repository and the associated VM.

In some embodiments, executing the computer-readable code is further configured to cause the at least one processing device to: identify at least one VM request; and generate, by the VM provisioning engine, the at least one VM based on the at least one VM request and at least one approved VM image associated with the VM request.

In some embodiments, the at least one address identifier comprises an internet protocol (IP) address associated with each VM.

In some embodiments, executing the computer-readable code is further configured to cause the at least one processing device to: run an address identifier resolver component at each address location associated with the at least one address identifier; track, by the address identifier resolver component, each VM in each address location; and confirm, by the address identifier resolver component, each VM is still running at each address location. In some embodiments, executing the computer-readable code is further configured to cause the at least one processing device to: determine a plurality of current VM components used in each VM; scan each VM image in the approved repository associated with each VM and determine the approved VM components for each VM image; compare the plurality of current VM components with approved VM components; and determine, based on the comparison, each VM that comprises current VM components that matches approved VM components are safe.

In some embodiments, executing the computer-readable code is further configured to cause the at least one processing device to: identify a list of new vulnerabilities, wherein the list of new vulnerabilities comprises at least one vulnerable VM component; update the VM vulnerability scanner with the list of new vulnerabilities; and identify, by the VM vulnerability scanner, at least one vulnerable VM image comprising the at least one vulnerable VM component from the list of new vulnerabilities. In some embodiments, executing the computer-readable code is further configured to cause the at least one processing device to: generate an alert interface component comprising at least one address identifier for at least one VM that is based on the at least one vulnerable VM image; and transmit the alert interface component to a user device associated with the at least one vulnerable VM image.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for tracking virtual machine image vulnerabilities in a distributed network, in accordance with an embodiment of the disclosure;

FIG. 2 illustrates a process flow for tracking virtual machine image vulnerabilities in a distributed network, in accordance with an embodiment of the disclosure;

FIG. 3 illustrates a process flow for generating at least one VM based on a VM request, in accordance with an embodiment of the disclosure;

FIG. 4 illustrates a process flow for determining each VM that comprises current VM components that match approved VM components are safe, in accordance with an embodiment of the disclosure;

FIG. 5 illustrates a process flow for identifying vulnerable VM images from a list of new vulnerabilities, in accordance with an embodiment of the disclosure; and

FIG. 6 illustrates a process flow for tracking virtual machine image vulnerabilities in a distributed network, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In virtual machine environments, it has become increasingly difficult, time consuming, and computing resource intensive to accurately and in real time track vulnerabilities in newly generated virtual images and in real time track newly identified vulnerabilities in virtual machines that have already been deployed to various data centers, servers, devices, and/or the like in a distributed network. Further, these issues are exacerbated where virtual machines have already been deployed on different network devices (various data centers, servers, devices, and/or the like) and new vulnerabilities are identified and each of these virtual machines have to be tracked down and updated, recalled, deleted, and/or the like, before the vulnerabilities cause network security issues, data security issues, and processing issues within the virtual machines. Thus, there exists a need or a system, computer program product, and computer implemented method that can accurately, efficiently, and automatically track virtual machine vulnerabilities in these distributed network environment.

Accordingly, the present disclosure provides the identification of a virtual machine (VM) image; the application of the identified VM image to a VM vulnerability scanner; the determination, by the VM vulnerability scanner, of the VM image is safe from a list of known vulnerabilities; and the updating, based on the VM vulnerability scanner, of an approved repository with the VM image that is determined as safe from known vulnerabilities. Further, the disclosure provides for the generation, by a VM provisioning engine, of at least one VM from the approved repository; the identification of at least one address identifier associated with the generated VM; and the updating of the approved repository with the identified at least one address identifier and link the at least one address identifier to the associated VM image the generated VM is based on.

In other words, the disclosure provides a system configured to scan virtual machine images when they're initially generated and index the current component package of the virtual machine based on the scan and determine pre-emptively if the virtual machine images comprises any vulnerable virtual machine components, and in an instance where the virtual machine image does not comprise any vulnerable virtual machine components, allow the virtual machine image to be used to generate and deploy a virtual machine. For instance, when the virtual machine image is requested by an external source, then the system may track and index all the IP addresses that receive the virtual machine generated from the virtual machine image. Upon identifying a vulnerability to the virtual machine image, the system may resolve the virtual machines across the different indexed IP addresses that currently use the virtual machine image as a template for their deployed virtual machines.

What is more, the present disclosure provides a technical solution to a technical problem. As described herein, the technical problem includes the tracking vulnerabilities in virtual machine images proactively and vulnerabilities in already deployed virtual machines after deployment. The technical solution presented herein allows for the automatic, accurate, and efficient tracking of virtual machine images and their associated virtual machines that have been deployed in distributed network environment, and the tracking of current and future vulnerabilities that may cause the virtual machines to be deleted, recalled, patched, and/or the like. In particular, the disclosure provided herein is an improvement over existing solutions to resolving vulnerabilities in virtual machine images and their deployed virtual machines, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

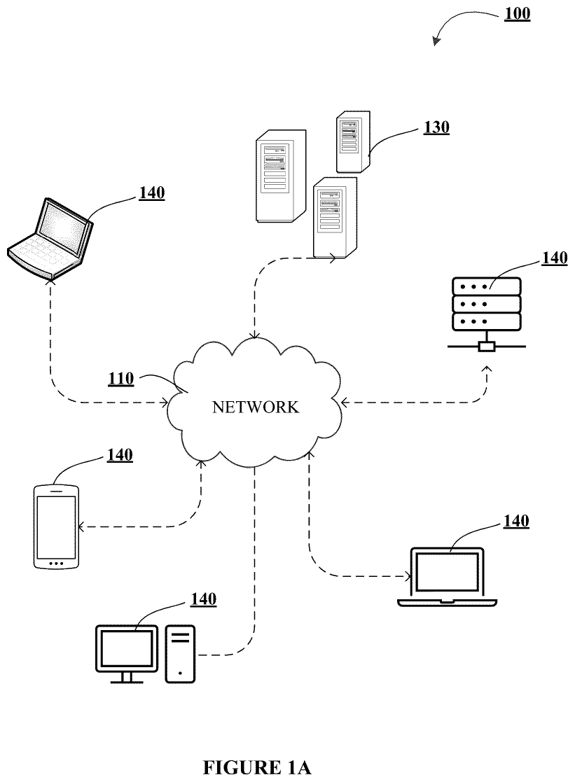

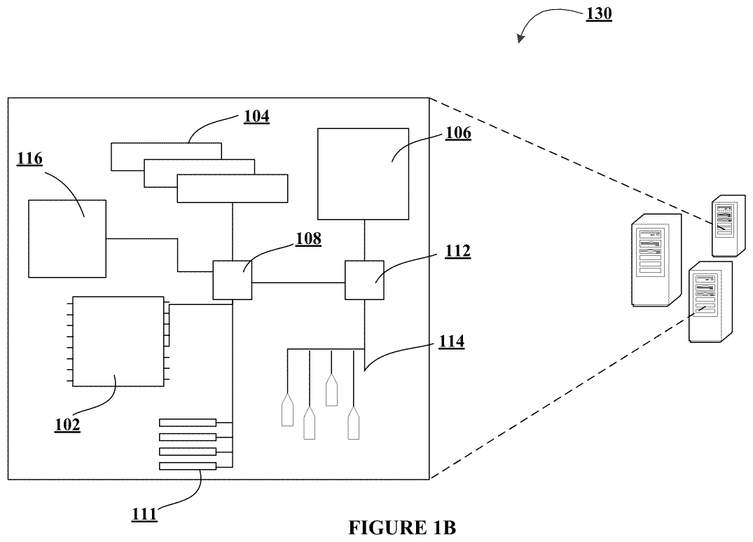

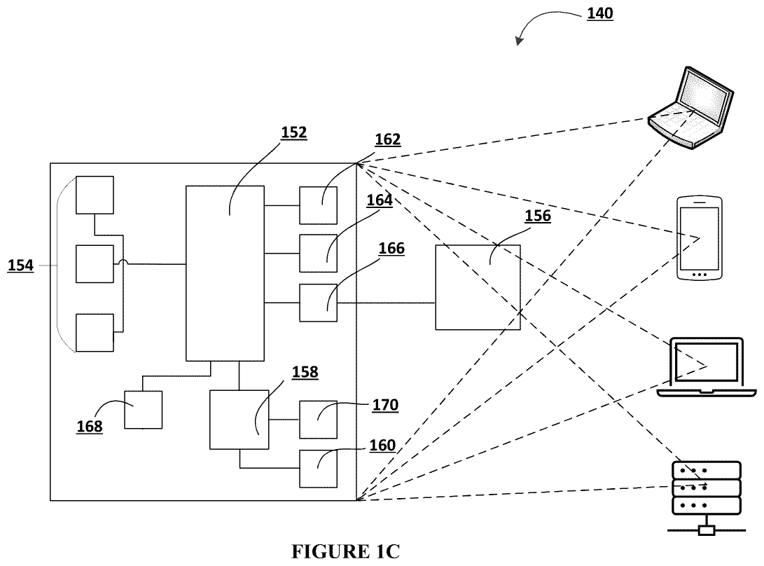

FIGS. 1A-1C illustrate technical components of an exemplary distributed computing environment for tracking virtual machine image vulnerabilities in a distributed network 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

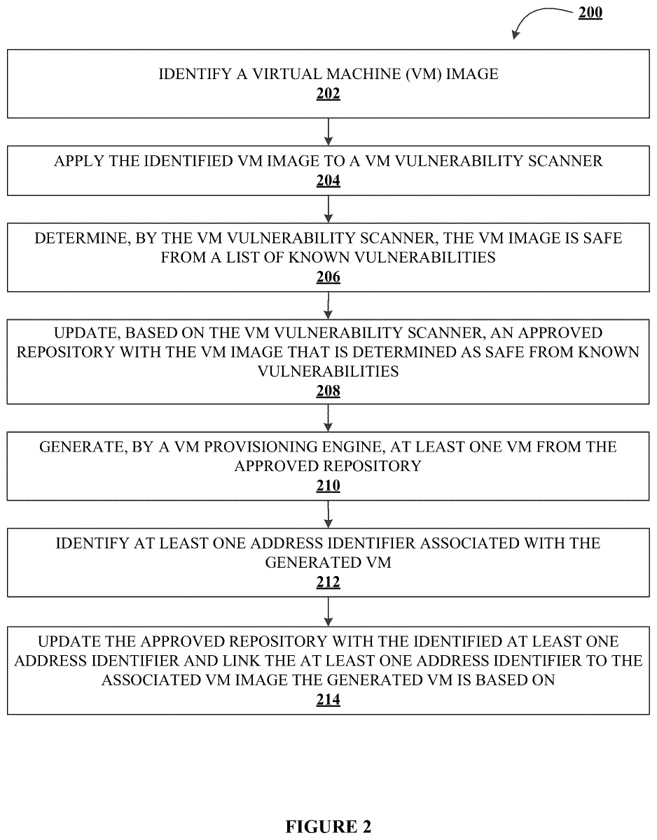

FIG. 2 illustrates a process flow 200 for tracking virtual machine image vulnerabilities in a distributed network, in accordance with an embodiment of the disclosure. In some embodiments, a system (e.g., similar to one or more of the systems described herein with respect to FIGS. 1A-1C) may perform one or more of the steps of process flow 200. For example, a system (e.g., the system 130 described herein with respect to FIG. 1A-1C) may perform the steps of process 200.

As shown in block 202, the process flow 200 includes the step of identifying a virtual machine (VM) image. For instance, the system may identify at least one virtual machine image, which may act as a template or snapshot for a virtual machine, whereby the virtual machine image may comprise a specific combination of virtual machine operating system(s), memory component(s), applications or services, disk components or properties, boot loader, root file system, and/or the like, which may each comprise their own specified properties or configurations to meet the intended purpose behind the generation of the VM image. In this manner, the VM image may be used by an entity, system, network, server, and/or the like, to spin up a real virtual machine (VM) in the same configuration as the underlying VM image used to create the VM.

In some embodiments, the VM image may be identified based on receiving the VM image from a generating source (such as but not limited to, a user that manually generated the VM image, an external source to the system described herein that manually and/or automatically generated the VM image, an internal source to the system described herein that manually and/or automatically generated the VM image, and/or the like). In some embodiments, the VM image may be generated by an external system (that sits outside of the network that houses, uses, and/or operates the system described herein), a platform designed to generate VM images for a particular purpose, a cloud computing platform, an image creator component (such as a VM image builder as a service or application that allows users to create, customize, and/or distributed custom VM images based on historical VM images and/or create new VM images from scratch).

Thus, and in some such embodiments, the system may identify the VM image(s) based on receiving the VM image(s) from a user accessing the system and/or the network that houses or uses the system, where such a user may apply or transmit the VM image for further analysis to the system. In some embodiments, the system may automatically identify any and all VM images introduced within its associated network, such that the system may act as a security measure within the network and/or within any external networks that generated the VM image to analyze the VM images and determine whether any vulnerabilities are present in the VM images before the VM images are used to generate the associated VMs. Thus, and in some such embodiments, the system may automatically identify all the VM images that enter the network and/or are generated within the network in real time or near real time to entering or being generated, respectively.

As shown in block 204, the process flow 200 includes the step of applying the identified VM image to a VM vulnerability scanner. For example, the system may apply the identified VM image(s) to a VM vulnerability scanner, which is designed and configured to determine whether the VM images are safe from known vulnerabilities. Such known vulnerabilities may be associated with the VM image's listed VM components (e.g., operating system(s), memory component(s), disk property(ies), applications or servers, and/or the like). For example, and in some embodiments, the VM vulnerability scanner may comprise an up-to-date list of each and every known vulnerability identified in historical VMs within the associated network or outside the associated network. In some such embodiments, the system may automatically scan for known vulnerabilities in an organization's tools, whereby the organization may be associated the network. In some embodiments, the system may additionally assess the severity of the identified vulnerabilities, the potential impact on the network and/or on specific components in the network, the likelihood of the vulnerable component(s) and their associated data being used by bad actors, and/or the like. In such embodiments, the system may attach a grade or severity level to each identified vulnerability, such that those VM images with greater, higher, or more severe vulnerabilities are handled first and foremost (e.g., the VM images are deleted and/or transmitted to a do not use repository).

In some embodiments, the system may identify VM vulnerabilities by identifying historical vulnerabilities from VMs internal to the network and/or VM images internal to the network, and compiling identified vulnerabilities as those components and/or configurations of the VM that caused the VM to not perform in its intended manner, that caused the VM to release secure data in an insecure manner or an unintended manner, that allowed misappropriation of data and/or components, and/or the like. In some embodiments, the VM vulnerability scanner may further comprise a database of each identified VM vulnerability, which may also comprise a list of known National Vulnerabilities (such as from the National Vulnerability Database (NVD)), and other such known vulnerability databases in the art.

Additionally, and in some embodiments, the VM vulnerability scanner may comprise adaptive scanning that actively and continuously scans the VM images as they are stored and used for generating new VMs for changes or updates to the underlying components, applications, configurations, network configurations, and/or the like. In some such embodiments, the adaptive scanning may occur in real time every time the VM image is used to generate a new VM and/or at pre-determined or scheduled times. Thus, and in some embodiments, the vulnerability scanner may re-scan the VM image regularly and at a predetermined interval. Additionally, and in some embodiments, the vulnerability scanner is updated in real time at an instance where a new vulnerability is identified. For instance, and whenever a new vulnerability is identified by the system and/or by the VM vulnerability scanner, the system and/or the VM vulnerability scanner may automatically and in real time or near real time, update its vulnerability database or repository which may store all the known vulnerabilities known by the VM vulnerability scanner and/or by the system. In some embodiments, the VM vulnerability scanner may re-scan the known VM images that are stored in the approved repository (which is discussed in further detail below) with the updated list comprising the new vulnerabilities, in real time or near real time to the system updating the VM vulnerability scanner. In some embodiments, the vulnerability scanner comprises each identified current vulnerability, such as by storing each identified vulnerability with its own vulnerability identifier (which may comprise a unique identifier that uniquely identifies each vulnerability within the network, within the system, and/or within the VM vulnerability scanner).

As shown in block 206, the process flow 200 may include the step of determining, by the VM vulnerability scanner, the VM image is safe from a list of known vulnerabilities. For example, the system may determine—using the VM vulnerability scanner—whether the VM image is safe from the list of known vulnerabilities (identified vulnerabilities). In some instances, and where a VM image comprises at least one component that matches a known vulnerability, then the system may determine the VM image is unsafe and may discontinue, delete, or move the VM image to a do not use database, such that VM image will not be used to generate a VM.

In some embodiments, and where the system—using the VM vulnerability scanner—determines that a VM image doesn't comprise any components (applications, operating system(s), memory components, disk properties, and/or the like) that match any of the known vulnerabilities, then the system may determine that VM image is safe and can be used to generate a VM (or a plurality of VMs with the same template). Thus, and as used herein, the VM images that are determined as safe, may be used as a template by the system, by a user within the network associated with the system, by an external user, an external organization, and/or the like, to generate a virtual machine (VM) that matches the component configuration of the safe VM image.

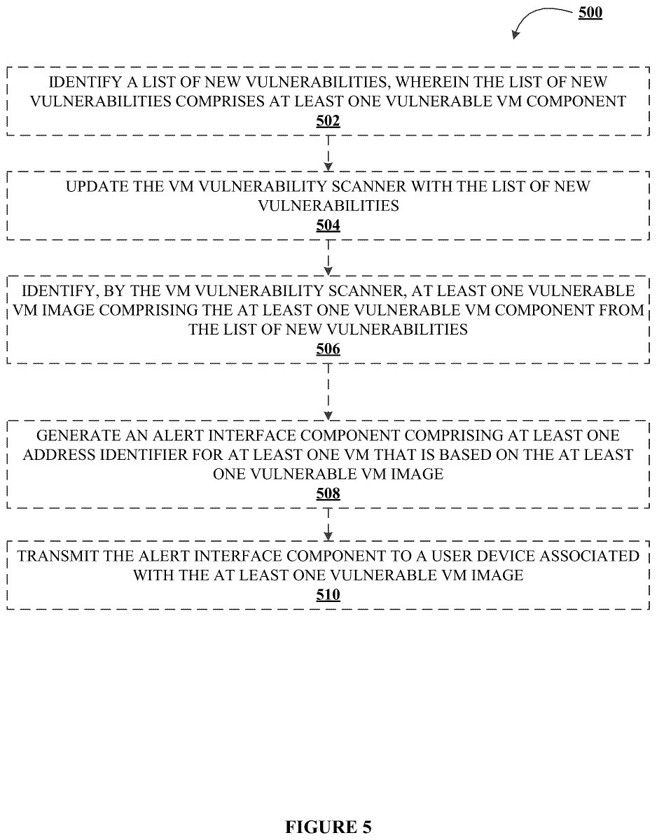

As shown in block 208, the process flow 200 may include the step of updating—based on the VM vulnerability scanner—an approved repository with the VM image that is determined as safe from known vulnerabilities. For instance, the system may update—based on the VM vulnerability scanner determine the VM image is safe from the known vulnerabilities—a repository of safe VM images (i.e., an approved repository) with the newly identified and determined as safe VM image. Thus, and in some such embodiments, the approved repository may comprise all the known and determined as safe VM images known by the system, and such an approved repository may be regularly and continuously updated to show the most current safe VM images that may be used to generate VMs. In some embodiments, and when a VM image that was previously determined as safe is no longer safe (such an instance may occur when the system —using the VM vulnerability scanner—updates with a new vulnerability and a previously approved VM image comprises a component associated with that new vulnerability) and the system must discontinue or delete the VMs that were generated from the now vulnerable VM image by first identifying all the VMs that were generated from the VM image within the approved repository, identifying each of their address locations (e.g., internet protocol (IP) addresses locations, device identifier, and/or the like), and deleting the VMs from their address locations. Such an embodiment is disclosed in further detail below with respect to FIG. 5.

In some embodiments, the approved repository further comprises a plurality of VM components used in each VM image of the approved repository and the associated VM. For example, and in some such embodiments, the approved repository may additionally comprise a detailed list of all the VM components used within the VM image (and, thus, will be used in the resulting VMs generated from the VM images). In some such embodiments, the listing of VM components may comprise component identifiers (e.g., the names of the components, the serial numbers of the components, the model of the components, and/or the like), component properties (e.g., memory size; CPU properties such as clock speed, cache size, core numbers, architecture designs, power efficiency, and/or the like; disk size; operating system types; and/or the like), component creator identifiers (e.g., the names of the entities or service providers that generated the component(s)), and/or the like. Thus, and in embodiments, the listing of the VM components used in the approved repository may be used by the system to determine which VM images and associated VMs may be vulnerable at a current time or future time without the need to scan the VMs themselves, which would save computing resources, network resources, and/or the like.

As shown in block 210, the process flow 200 may include the step of generating—by the VM provisioning engine—at least one VM from the approved repository. For instance, the system may generate—using a VM provisioning engine—at least one VM from the approved repository of VM images. Thus, and as used herein, the VM provisioning engine may be designed and configured to generate virtual machines that are based on a VM image stored in the approved repository. In some embodiments, the VM provisioning engine may automatically generate and deploy at least one VM based on an approved VM image from the approved repository, whereby the deployed VM may be deployed to at least one server located external or internal to the associated network by allocating computing resources of the server to support the VM and allocating the correct VM components to the deployed VM to match the associated VM image. In some embodiments, the VM provisioning engine may receive a request internal to the network or external to the network (e.g., from a user internal or external to the network) comprising a request to generate a VM (or a plurality of VMs) based on a specified VM image and/or based on a listing of VM image properties or intended purpose that may be matched by the system or the VM provisioning engine to an approved VM image. In this manner, the VM provisioning engine may be configured to match the VM request to at least one VM image from the approved repository, and automatically generate at least one VM from the at least one identified VM image.

As shown in block 212, the process flow 200 may include the step of identifying at least one address identifier associated with the generated VM. For instance, the system may identify at least one address identifier for whether the VM will be deployed to, such as a server identifier, an internet protocol (IP) address, a device identifier, a data center identifier, and/or the like. In this manner, the system may keep a list of each location each VM is deployed to (a list of address identifiers for each VM image). In some embodiments, the system may update the list whenever a VM is deleted from the location of its deployment, moved to a new location, and/or the like. In some embodiments, the address identifier may be stored in the approved repository along with each VM image identifier (identifying each individual VM image), and in some embodiments each package of VM components used in each VM image.

As shown in block 214, the process flow 200 may include the step of updating the approved repository with the identified at least one address identifier and link the at least one address identifier to the associated VM image the generated VM is based on. For example, the system may update the approved repository with the identified at least one address identifier for each VM image whenever a new VM is generated and deployed to an address identifier, and each address identifier of a VM may be linked within the approved repository with the associated VM image identify the VM is based on. In this manner, the approved repository may keep an up to date and easily accessible list of each address identifier a VM is deployed on and the associated VM image identifier that was used to generate the VM. In some embodiments, the approved repository may comprise a listing of each VM image identifier, address identifier(s), package of VM components, and/or the like, a map comprising nodes and edges between each VM image identifier and the associated address identifier(s) and package of VM component(s), and/or the like.

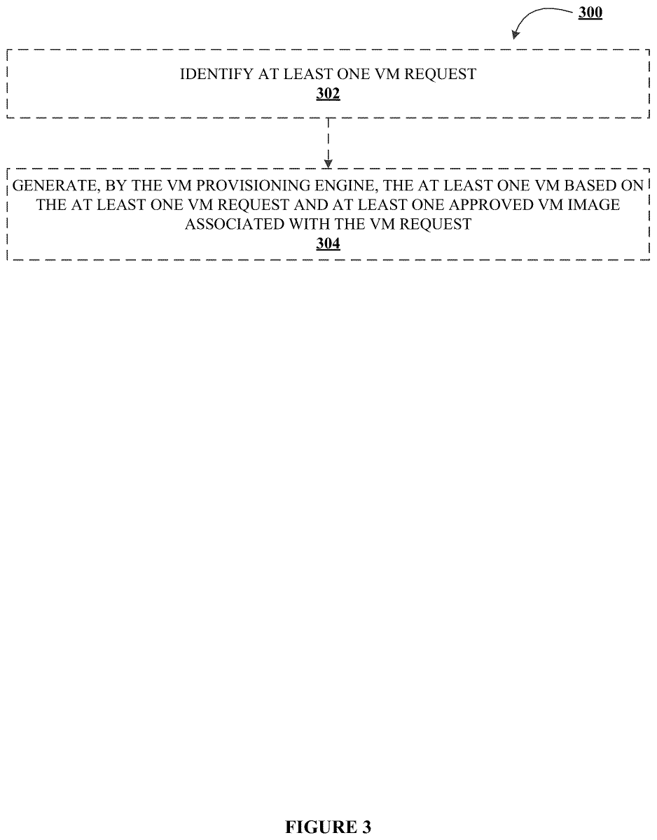

FIG. 3 illustrates a process flow 300 for generating at least one VM based on a VM request, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300.

In some embodiments, and shown in block 302, the process flow 300 may include the step of identifying at least one VM request. For instance, and in some such embodiments, the system may identify at least one VM request from an external user of the network, by an internal user of the network (such as a user associated with an organization that uses or manages the network), and/or the like. In some embodiments, the VM request may comprise a VM image identifier that the user intends the VM to be based on. In some additional embodiments, the VM request may comprise an intention for the intended VM, such as an intention or purpose for the VM to complete. Such an intention or purpose may be received by the system and parsed by a natural language processor (NLP) to identify key words and/or phrases that may be used by the VM provisioning engine to match to the most similar VM image that can perform the intended purpose of the intention provided by the user. In some embodiments, the VM request may be generated by the system itself, such as where the system has automatically identified a need that must be filled that may increase processing speeds, increase memory capacity within its system, increase CPU power, and/or the like. Additionally, and in some embodiments, the VM request may comprise a location for the VM to be deployed (or a plurality of locations where a plurality of VMs are needed).

In some embodiments, and as shown in block 304, the process flow 300 may include the step of generating, by the VM provisioning engine, the at least one VM based on the at least one VM request and at least one approved VM image associated with the VM request. Thus, and based on the system identifying the at least one VM request, the system may—using the VM provisioning engine—generate and deploy the at least one VM based on at least one VM image from the approved repository. In this manner, the generated VM that is based on the at least one approved VM image may be a deployable replica of the templated shown in the VM image from the approved repository. Thus, and based on this generation of the VM(s), the system may automatically deploy each generated VM to its intended location (e.g., IP address, data center, server, device, and/or the like) for use.

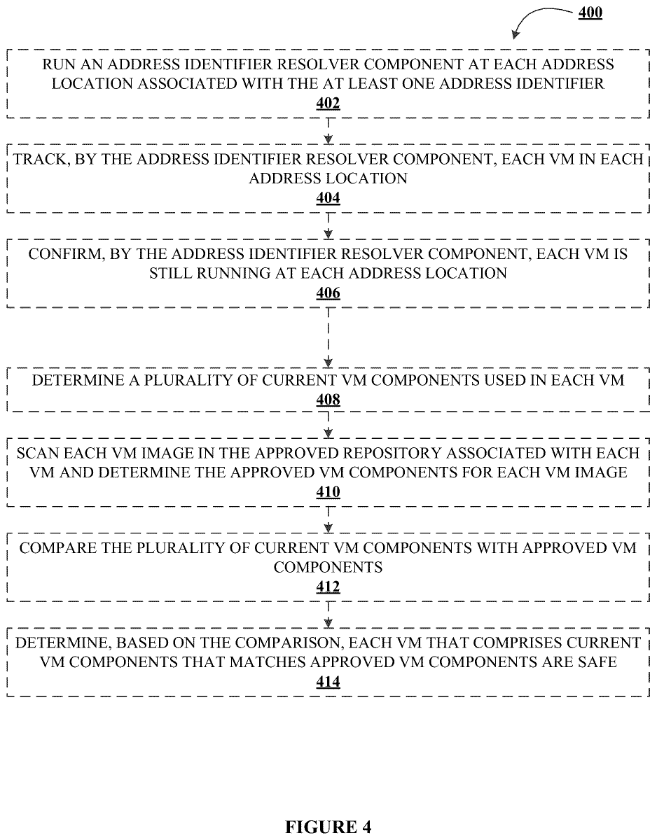

FIG. 4 illustrates a process flow 400 for determining each VM that comprises current VM components that match approved VM components are safe, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400.

In some embodiments, and as shown in block 402, the process flow 400 may include the step of running an address identifier resolver component at each address location associated with the at least one address identifier. For example, and in some such embodiments, the system may run an address identifier resolver component which may run in the background of the system, in the background of the approved repository, and/or in the background of each address location. Such an address identifier resolver component may be configured to keep track of the current list of VM images that are actually being used on an external network (e.g., at each address location, such as at each data center, server, IP address, device, and/or the like). In some embodiments, the address identifier resolver component may be deployed with each VM at the time of the original generation and deployment of a VM, such that the address identifier resolver runs in the background at each deployment location from the start of the VM being deployed at the deployment location, until the VM is no longer being used at the deployment location, is deleted from the deployment location, and/or the like. In some embodiments, the address identifier resolver component may periodically and continuously send an update message to the system (such as across the network from the deployment location back to the system), indicating whether the VM is still running at the deployment location.

In some embodiments, and as shown in block 404, the process flow 400 may include the step of tracking, by the address identifier resolver component, each VM in each address location. For example, and in some embodiments, the system may track—using the address identifier resolver component—whether each deployed VM at each deployment location is still being used. In some embodiments, the address identifier resolver component may further be configured to determine whether any changes or updated have been applied to the deployed VMs that may not have been generated and deployed from the system (such as a patch generated and deployed by the system). Thus, and in such an embodiment, the system may determine whether the VM deployed at the address location has been tampered with, and thus, may be vulnerable to future tampering and/or vulnerable to data security issues, hacking, network security, and/or the like. In some such embodiments, the address identifier resolver component may compare the most recent version of the VM to determine if any updates or changes have been applied to the current version analyzed by the address identifier resolver component. In this manner, and importantly, the address identifier resolver component may save computing and memory resources by not saving and staring each version or iteration of each VM for this comparison.

In some embodiments, and as shown in block 406, the process flow 400 may include the step of confirming, by the address identifier resolver component, each VM is still running at each address location. For example, and in some such embodiments, the system may confirm—based on the tracking o f each VM at the address location—that each VM at each address location is running (being used, being used correctly, and/or being used as the same version that was originally deployed and/or the same version that was deployed and patched by the system, when applicable). Thus, and based on this confirmation, the system may determine that the deployed VMs that are confirmed as still running at each address location are safe and are not vulnerable. However, and where the system has determined that a new vulnerability has been identified by the VM vulnerability scanner, then the system may determine that the VM deployed and running at the address location is vulnerable even if the VM is still running at the intended deployment location. Such an embodiment is described in further detail below.

In some embodiments, and as shown in block 408, the process flow 400 may include the step of determining a plurality of current VM components used in each VM. For instance, and in some embodiments, the system may determine a plurality of current VM components that are currently being used in each VM actively deployed at each address location. In some embodiments, these VM components may be identified by the address identifier resolver component and/or another component configured to determine each of the VM components at use in each VM currently in use. In some such embodiments, such a component configured to determine the active VM components at each VM may be deployed at the address location that deploys the VM, at the time the VM was deployed to the address location. In some such embodiments, such a component may be referred to as a VM component identifier. In some embodiments, the VM component identifier (and/or the address identifier resolver component) may be generated and configured to scan the VM(s) at the associated address location. In some embodiments, and upon scanning and collecting the VM components (e.g., the VM component identifiers) that are currently at use at the VM, the system may receive (from the VM component identifier and/or the address identifier resolver component) a message comprising the VM components currently in use at each VM deployed at each address location.

In some embodiments, and as shown in block 410, the process flow 400 may include the step of scanning each VM image in the approved repository associated with each VM and determining the approved VM components for each VM image. For example, and in some embodiments, the system may scan each VM image in the approved repository that is associated with each VM that the system received the VM component identifiers for, and determine whether all the VM component identifiers in the deployed VMs match the VM components in the associated VM images.

In some embodiments, and as shown in block 412, the process flow 400 may include the step of comparing the plurality of current VM components with approved VM components. For instance, and in some instances, and where at least one VM component identifier in the deployed VM is different (based on component identifier, component property, and/or the like) than any of the VM components in VM image, then the system may determine that VMs deployed at the address location are vulnerable and were updated or hacked by a bad user, a bad network, a bad actor, and/or the like. Thus, and in some such embodiments, the system may identify—using the approved repository the address locations where any other VMs that were based on the same VM image are located and may recall or request those deployed VMs be deleted to avoid future tampering, hacking, data security issues, network security issues, and/or the like. Alternatively, and in an instance where the VM components of the VM image matches all the VM component identifiers deployed on the identified VM, then the system may determine that the approved VM components are correct for the VM and that the VM may continue to be run at the address location.

In some embodiments, and as shown in block 414, the process flow 400 may include the step of determining—based on the comparison—each VM that comprises current VM components that matches approved VM components are safe. For example, and in some embodiments, the system may determine that each VM deployed at the address location(s) based on a VM image that comprises the VM components that match the VM component identifiers of at least one VM are safe from known vulnerabilities. However, and in some embodiments, the system may continuously and at pre-determined intervals run this same process of FIG. 4 to continuously determine that each VM deployed at each address location is still safe from hacking, tampering, network security issues, data security issues, and/or the like. In some such embodiments, this continuous analysis of each VM at each address location may occur for each deployed VM associated with an identified VM image all at once and in parallel, and/or may occur for one deployed VM associated with an identified VM image one at a time until each deployed VM has been analyzed. Thus, and based on the process described herein, the system may scan the VM images, and this ensures that the VMs that are deployed are safe on an ongoing basis by scanning them while they are up and live.

FIG. 5 illustrates a process flow 500 for identifying vulnerable VM images from a list of new vulnerabilities, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500.

In some embodiments, and as shown in block 502, the process flow 500 may include the step of identifying a list of new vulnerabilities, wherein the list of new vulnerabilities comprises at least one vulnerable VM component. Thus, the system may determine whether any active VMs and/or VM images comprise the same vulnerable VM component, and thus, are likewise vulnerable and should be discontinued, deleted, and/or the like. For example, and in some such embodiments, the system may identify a list of new vulnerabilities and/or identify just one new vulnerability based on scanning VM images, deployed VMs, scanning internet environments, databases, and/or the like. Based on this identification of at least one new vulnerability, the system may identify at least one vulnerable VM component that may have caused the new vulnerability, indirectly caused the new vulnerability, and/or the like. Thus, the system may identify the new vulnerability(ies) and its associated vulnerability component(s) that was identified as causing the vulnerability. In some embodiments, these newly identified vulnerability may be identified using the same or similar methods as those described above for identifying the vulnerabilities in FIG. 2.

In some embodiments, and as shown in block 504, the process flow 500 may include the step of updating the VM vulnerability scanner with the list of new vulnerabilities. For instance, the system may update the VM vulnerability scanner (and in some embodiments, its database(s) or listing of known vulnerabilities) with the newly identified vulnerability(ies). Such an updating of the VM vulnerability scanner may occur in real time or near real time to identifying the new vulnerability(ies).

In some embodiments, and as shown in block 506, the process flow 500 may include the step of identifying, by the VM vulnerability scanner, at least one vulnerable VM image comprising the at least one vulnerable VM component from the list of new vulnerabilities. For example, and in some such embodiments, the system may identify—using the VM vulnerability scanner—at least one vulnerable VM image that comprises a VM component that was identified with the newly identified vulnerability(ies). In this manner, the system may automatically and in real time or near real time to updating the VM vulnerability scanner apply the updated VM vulnerability scanner to the approved repository, and the updated VM vulnerability scanner will determine whether any previously approved VM images are no longer safe from known vulnerabilities. In some embodiments, and where none of the VM images comprise any VM components that match the new vulnerability(ies) and their vulnerable VM component(s), then the system may determine that all the VM images in the approved repository are still safe. However, and in an instance where at least one VM image is determined as having a VM component that matches at least one of the vulnerable VM components, then the system may determine the at least one VM image is no longer safe and any VMs deployed that match the VM image should be deleted, recalled, discontinued, a patch should be applied (where available), and/or the like at each deployed address location identified in the approved repository.

In some embodiments, and as shown in block 508, the process flow 500 may include the step of generating an alert interface component comprising at least one address identifier for at least one VM that is based on the at least one vulnerable VM image. For instance, and in some embodiments, the system may generate an alert interface component comprising the data associated with the newly identified vulnerable VM image (e.g., the vulnerable VM component, the address identifier where the associated VM based on the vulnerable VM image was deployed on, and/or the like) as a data packet that is transmissible over a network (such as the network shown in FIG. 1A) to a user device associated with the deployed VM. In some embodiments, each alert interface component may be generated specific to each VM, such that the VM identified within the alert interface component (and that needs to be recalled, deleted, patched, and/or the like due to its VM image's vulnerability) will determine which user device will receive it and which data will be comprised within the alert interface component (e.g., only the data associated with the VM that the user of the user device operates, manages, and/or can access). Thus, and in some embodiments, the system may generate a plurality of alert interface components for one VM image, whereby each alert interface component may be specific to one or more VMs that are operated, managed, and/or controlled by a user associated with the recipient user device, and each alert interface component may be transmitted to their respective user devices in parallel or in near real time to each other.

In some embodiments, the alert interface component may additionally and/or alternatively comprise a fix for the vulnerable VM, such as a command to recall the VM from the address location, a delete command of the VM at the address location, a sandbox command to isolate the VM in the address location (such as until a patch is generated), a patch command to fix the vulnerability (such as with an equivalent VM component that is determined as safe), and/or the like. In some such embodiments, such a fix may be automatically generated by the system.

In some embodiments, and as shown in block 510, the process flow 500 may include the step of transmitting the alert interface component to a user device associated with the at least one vulnerable VM image. For instance, and in some such embodiments, the system may automatically transmit the alert interface component to the identified user device for the associated VM deployed on a network, device, server, data center, and/or the like that is associated with the user device or the user of the user device. In some embodiments, the user device that receives the alert interface component may be the deployment device for the associated VM, the address location of the VM, and/or the like, and the user device may be configured—based on a command within the alter interface component—to automatically delete, recall, sandbox, seclude, apply a patch, and/or the like to the identified VM associated with the vulnerable VM image.

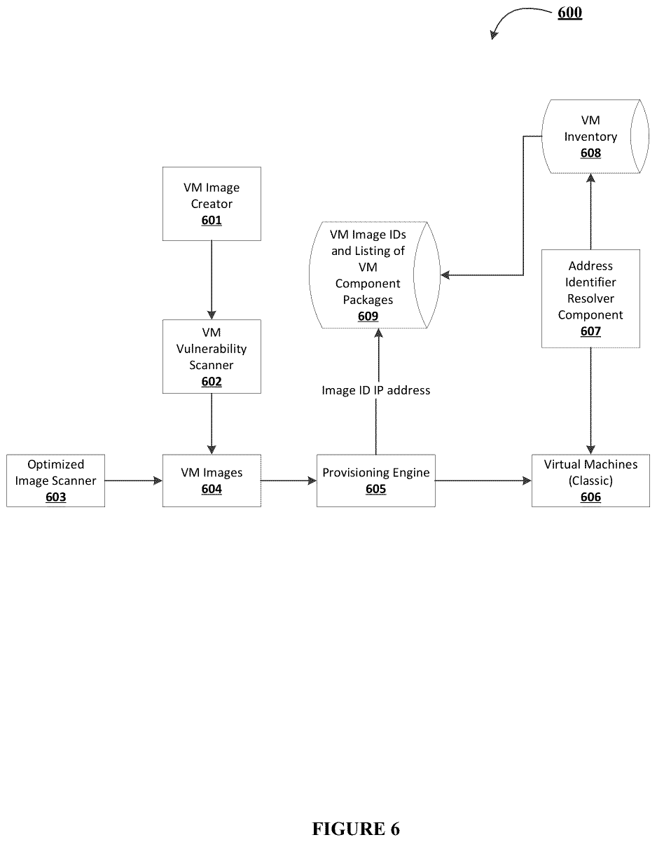

FIG. 6 illustrates a flow diagram 600 for tracking virtual machine image vulnerabilities in a distributed network, in accordance with an embodiment of the disclosure. In some embodiments, a system (e.g., similar to one or more of the systems described herein with respect to FIGS. 1A-1C) may perform one or more of the steps of flow diagram 600. For example, a system (e.g., the system 130 described herein with respect to FIG. 1A-1C) may perform the steps of flow diagram 600.

As shown in flow diagram 600, the process for tracking virtual machine image vulnerabilities is shown and described as a full flow diagram. For instance, and as shown in block 601, the system may comprise a VM image creator which may be configured to receive a VM request comprising the specific VM components intended for the VM image (and its associated VMs), a VM request comprising an intention or purpose for the VM which the VM image creator may automatically generate the VM image from, and/or the like. Based on this generated VM image, a VM vulnerability scanner 602 may be used by the system to scan the VM components used in the VM image to determine whether any of the VM components are vulnerable (e.g., match a database of known vulnerabilities), and in an instance where none of the VM components are vulnerable, determine that the generated VM image is safe.

In some embodiments, and as shown in block 603, an optimized image scanner may be employed by the system to identify and collect each of the VM components employed within each approved VM image determined as safe. In this manner, the system may collect a full listing of each VM component used in each VM image, which may in turn be input to both the provisioning engine 605 to generate the associated VM(s) and to the VM Image Identifiers and Listing of VM component Packages 609 (which may comprise a database, a repository and/or the like, such as an approved repository). In some embodiments, this optimized image scanner may be comprised within the VM vulnerability scanner and/or may be combined with the VM vulnerability scanner and configured within the VM vulnerability scanner as a function of the VM vulnerability scanner.

Additionally, and in some embodiments, and upon generating the VM from the VM images in the approved repository, the provisioning engine 605 may also transmit the address locations (i.e., Image ID IP addresses) for the generated VMs to the VM Image IDs and Listing of VM Component Packages database/repository 609. Further, and upon generating the VM(s) from the VM images, the system may transmit the data of the VMs and/or the VMs themselves to the virtual machines (classic) component, which may be connected to an external network and/or to the address locations that will deploy the VMs at the intended deployment locations. Further, and upon deploying the VMs to each deployment location, the system may additionally apply the address identifier resolver component which can determine, continuously and/or periodically, that each VM deployed is still being used at the intended deployment location(s). Such data may be input to the VM inventor database and/or repository 608, may in turn be input back to the VM images IDs and listing of VM component packages 609 for comparison to the originally generated VM images for confirmation that the deployed VM images are still safe. In some embodiments, the VM inventor 608 may be comprised within the VM images IDs and listing of VM component packages 609 and the VM images IDs and listing of VM component packages 609 may be synonymously referred to as the approved repository.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for tracking virtual machine image vulnerabilities in a distributed network, the system comprising:
a memory device with computer-readable program code stored thereon;
at least one processing device operatively coupled to the at least one memory device and at least one communication device, wherein executing the computer-readable code is configured to cause the at least one processing device to:
identify a virtual machine (VM) image;
apply the identified VM image to a VM vulnerability scanner;
determine, by the VM vulnerability scanner, the VM image is safe from a list of known vulnerabilities;
update, based on the VM vulnerability scanner, an approved repository with the VM image that is determined as safe from known vulnerabilities;
generate, by a VM provisioning engine, at least one VM from the approved repository;
identify at least one address identifier associated with the generated VM; and
update the approved repository with the identified at least one address identifier and link the at least one address identifier to the associated VM image the generated VM is based on.

2. The system of claim 1, wherein the VM image is generated by at least one of an external system, a platform, a cloud computing platform, or an image creator component.

3. The system of claim 1, wherein the vulnerability scanner re-scans the VM image regularly and at a predetermined interval.

4. The system of claim 1, wherein the vulnerability scanner is updated in real time at an instance where a new vulnerability is identified.

5. The system of claim 1, wherein the approved repository further comprises a plurality of VM components used in each VM image of the approved repository and the associated VM.

6. The system of claim 1, wherein executing the computer-readable code is further configured to cause the at least one processing device to:
identify at least one VM request; and
generate, by the VM provisioning engine, the at least one VM based on the at least one VM request and at least one approved VM image associated with the VM request.

7. The system of claim 1, wherein the at least one address identifier comprises an internet protocol (IP) address associated with each VM.

8. The system of claim 1, wherein executing the computer-readable code is further configured to cause the at least one processing device to:
run an address identifier resolver component at each address location associated with the at least one address identifier;
track, by the address identifier resolver component, each VM in each address location; and
confirm, by the address identifier resolver component, each VM is still running at each address location.

9. The system of claim 8, wherein executing the computer-readable code is further configured to cause the at least one processing device to:
determine a plurality of current VM components used in each VM;
scan each VM image in the approved repository associated with each VM and determine the approved VM components for each VM image;
compare the plurality of current VM components with approved VM components; and
determine, based on the comparison, each VM that comprises current VM components that matches approved VM components are safe.

10. The system of claim 1, wherein executing the computer-readable code is further configured to cause the at least one processing device to:
identify a list of new vulnerabilities, wherein the list of new vulnerabilities comprises at least one vulnerable VM component;
update the VM vulnerability scanner with the list of new vulnerabilities; and
identify, by the VM vulnerability scanner, at least one vulnerable VM image comprising the at least one vulnerable VM component from the list of new vulnerabilities.

11. The system of claim 10, wherein executing the computer-readable code is further configured to cause the at least one processing device to:
generate an alert interface component comprising at least one address identifier for at least one VM that is based on the at least one vulnerable VM image; and
transmit the alert interface component to a user device associated with the at least one vulnerable VM image.

12. A computer program product for tracking virtual machine image vulnerabilities in a distributed network, wherein the computer program product comprises at least one non-transitory computer-readable medium having computer-readable program code portions embodied therein, the computer-readable program code portions which when executed by a processing device are configured to cause the processor to:
identify a virtual machine (VM) image;
apply the identified VM image to a VM vulnerability scanner;
determine, by the VM vulnerability scanner, the VM image is safe from a list of known vulnerabilities;
update, based on the VM vulnerability scanner, an approved repository with the VM image that is determined as safe from known vulnerabilities;
generate, by a VM provisioning engine, at least one VM from the approved repository;
identify at least one address identifier associated with the generated VM; and
update the approved repository with the identified at least one address identifier and link the at least one address identifier to the associated VM image the generated VM is based on.

13. The computer program produce of claim 12, wherein the vulnerability scanner is updated in real time at an instance where a new vulnerability is identified.

14. The computer program produce of claim 12, wherein the approved repository further comprises a plurality of VM components used in each VM image of the approved repository and the associated VM.

15. The computer program produce of claim 12, wherein the application decommission indicator comprises the retire and retain data only request, and wherein the processing device is configured to cause the processor to:
identify at least one VM request; and
generate, by the VM provisioning engine, the at least one VM based on the at least one VM request and at least one approved VM image associated with the VM request.

16. The computer program produce of claim 12, wherein the at least one address identifier comprises an internet protocol (IP) address associated with each VM.

17. A computer implemented method for tracking virtual machine image vulnerabilities in a distributed network, the computer implemented method comprising:
identifying a virtual machine (VM) image;
applying the identified VM image to a VM vulnerability scanner;
determining, by the VM vulnerability scanner, the VM image is safe from a list of known vulnerabilities;
updating, based on the VM vulnerability scanner, an approved repository with the VM image that is determined as safe from known vulnerabilities;
generating, by a VM provisioning engine, at least one VM from the approved repository;
identifying at least one address identifier associated with the generated VM; and
updating the approved repository with the identified at least one address identifier and link the at least one address identifier to the associated VM image the generated VM is based on.

18. The computer implemented method of claim 17, wherein the vulnerability scanner is updated in real time at an instance where a new vulnerability is identified.

19. The computer implemented method of claim 17, wherein the approved repository further comprises a plurality of VM components used in each VM image of the approved repository and the associated VM.

20. The computer implemented method of claim 17, further comprising:
identifying at least one VM request; and
generating, by the VM provisioning engine, the at least one VM based on the at least one VM request and at least one approved VM image associated with the VM request.
